(19) United States
(12) Patent Application Publication
(10) Pub. No.: US 2004/0011061 A1
(43) Pub. Date: Jan. 22, 2004

(54) Device and process for the cryogenic filling of aerosol product batches

(76) Inventors: Andre Bitz, Gensingen (DE); Detlef Jankowski, Krefeld (DE); Thomas Kraft, Ingelheim (DE); Thomas Kutz, Bruggen-Born (DE)

Correspondence Address: CONNOLLY BOVE LODGE & HUTZ LLP, 1220 MARKET STREET, P.O. BOX 2207, WILMINGTON, DE, 19899, US

(21) Appl. No.: 10/319,160

(22) Filed: Dec. 13, 2002

(30) Foreign Application Priority Data
Dec. 14, 2001 (DE) 101 61 368.7-13

(51) Int. Cl. F17C 13/02; F25D 17/02

(52) U.S. Cl. 62/64; 62/49.1

(57) ABSTRACT

In order to avoid evaporation of the propellant gas during the pressure-free filling of an aerosol formulation provided with a readily volatile propellant gas, the product to be filled is cooled prior to being fed into a metering means. In this context, fluoro-chlorinated hydrocarbons such as, for instance, R11 have been used up until now as the coolant, but their use is no longer permitted in Germany and in other nations.

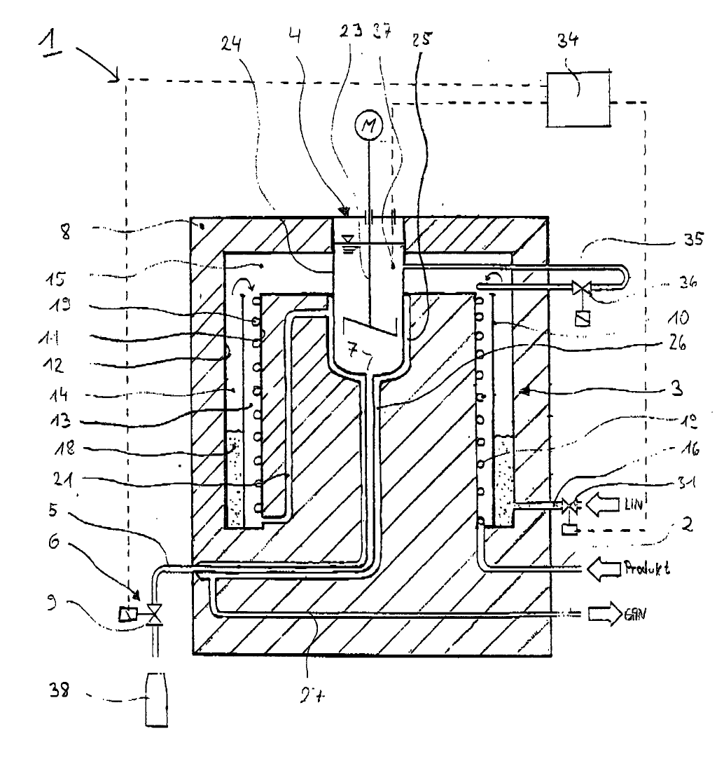

Consequently, it is proposed according to the invention that an evaporator be installation upstream from the heat exchanger employed to cool the aerosol product batch, in which evaporator a liquid coolant is evaporated and then brought to the temperature required to cool the aerosol product batch by a regulating means.

The invention makes it possible to employ environmentally safe coolants such as, for instance, nitrogen, without running the risk that the aerosol formulation will freeze during the cooling procedure. In this context, the invention allows the coolant temperature to be selected at will over a wide range.

Device and process for the cryogenic filling of aerosol product batches The invention relates to a device to cool liquefied aerosol product batches which are to be nebulized by means of a propellant gas, especially pharmaceutical formulations, and it also relates to a device and a process for the filling procedure thereof.

Pharmaceutical aerosol formulations consist of an active ingredient that is suspended or dissolved in a propellant gas. Examples of propellant gases used for this purpose are fluorochlorinated hydrocarbons, fluorinated hydrocarbons, alkanes such as propane, butane, pentane, dimethyl ether, CO₂ or nitrogen, or else mixtures thereof. Fluorinated hydrocarbons are especially preferred. Such aerosol formulations are stored in pressure-proof storage tanks at ambient temperature, whereby a vapor pressure of 3 bar to 4 bar builds up as a result of evaporation of the readily volatile propellant gas. In order to avoid evaporation of the propellant gas during the filling of the aerosol canisters such as spray cans or inhalers, the product is either filled under pressure (pressurized filling) or else the product is cooled down prior to the actual filling procedure in order to lower the vapor pressure of the propellant gas (cold filling).

In the case of the above-mentioned propellant gases, the cold filling normally involves cooling to a temperature of about −45° C. [−49° F.]. Lower temperatures are also possible. Here, the cooling is done in heat exchangers that so far have been cooled by means of a secondary circulation system operated with trichlorofluoromethane (R11) in a cooling machine. In Germany as well as in several other nations, however, the use of R11 as a coolant is no longer permitted because of its environmentally harmful effect.

The use of environmentally safe coolants such as, for instance, liquefied nitrogen, has failed up until now because the low boiling temperature causes at least partial freezing of the product being filled.

Consequently, the objective of the present invention is to create a way to cool and fill aerosol formulations that can make do without the use of fluorochlorinated hydrocarbons or comparable substances that are harmful to the environment.

This objective is achieved by means of a device having the features cited in Patent claim 1.

The invention claims a device for the cryogenic cooling of aerosol formulations, an evaporator for a liquid coolant, a heat exchanger that is in flow connection with the evaporator for purposes of establishing thermal contact between the evaporated coolant and the aerosol formulation, as well as a control unit to regulate the cooling capacity of the heat exchanger. In the process according to the invention, the aerosol formulation does not come into direct contact with the coolant since the coolant is kept in a separate circulation system. The cold is transmitted through the surface of the heat exchanger, which can be made of stainless steel. The cooling itself is brought about with a gaseous coolant that was previously produced by evaporating a liquid coolant and that is kept by means of the control unit at a temperature that lies above the boiling temperature of the coolant. This allows the use of environmentally safe coolants such as, for example, nitrogen, without running the risk that the propellant or the product will freeze during the cooling procedure. At the same time, the filling device according to the invention makes it possible to achieve target temperatures for the substance to be cooled that lie below the temperatures that could be reached until now using the coolant R11.

For this purpose, it is advantageous for the control unit to have means that serve to regulate the inflow of liquid coolant to the evaporator. In this manner, the cooling capacity of the heat exchanger can be adapted very efficiently to the requirements at hand.

A preferred embodiment of the invention comprises an electronic control unit which, as a function of a prescribed target value for the temperature or of a specified target temperature course, actuates the regulating means that serves to regulate the temperature of the coolant and/or to regulate the inflow of liquid coolant.

It has been found to be particularly advantageous to install a cooling device according to the invention in a filling device used for pharmaceutical aerosol formulations. This device is fitted with a feed line for withdrawing an aerosol formulation from a pressure tank and with a product outflow line for feeding the aerosol formulation to a metering means. The metering means is located upstream from a cooling device of the above-mentioned type.

According to a preferred embodiment of the invention, in order to homogenize the aerosol formulation that is to be filled, the feed line is in flow connection with a buffer tank. With an eye towards further improving the homogeneity of the aerosol formulation, the buffer tank is preferably equipped with an agitator.

For purposes of cooling the substance held in the above-mentioned buffer tank, the latter is preferably provided, at least partially, with a double wall and a coolant can flow through the cavity formed between the walls of this double wall. Such an arrangement accounts for a particularly effective cooling of the substance in the buffer tank as well. In an advantageous manner, the same coolant is used as the one employed in the heat exchanger.

Alternatively, a mobile cooling coil can be employed to cool the batch, whereby the coil is attached, for example, to a lid of the buffer tank and it is immersed into the batch. The cooling medium can be water.

In this embodiment—as well as in other embodiments—it is not absolutely necessary for the buffer tank to have a double wall. It can also have just a single wall.

Advantageously, the cooling device comprises a pre-cooler located upstream from the buffer tank, as a result of which the substance to be filled is fed to the buffer tank already in the cold state.

An advantageous improvement of the invention provides for the feed line and/or the product outflow line to be associated with a means that serves to reduce the pressure to ambient pressure and that is located downstream from the pre-cooler. Therefore, the filling of the substance takes place without pressure. The pressure reduction in the cooled state especially avoids uncontrolled pressure fluctuations which would inevitably occur in the case of a pressure reduction in the still warm state.

The envisaged objective is also achieved by means of a process to fill aerosol formulations, said process having the features cited in Patent claim 9.

Here, an aerosol formulation is cooled in a heat exchanger through thermal contact with a coolant, after which it is conveyed in the cold state to a metering means used for filling the product into aerosol canisters, a process which makes use of a liquefied gas as the coolant that is evaporated prior to thermal contact with the aerosol product batch. As a result, it is likewise possible to employ coolants whose boiling temperature lies far below the freezing temperature of the aerosol product batch.

Advantageously, the temperature of the evaporated liquefied gas is regulated by the feed of liquefied gas. Thus, the invention allows the temperature of the coolant to be selected at will over a wide range above the melting temperature of the coolant.

Nitrogen has turned out to be a particularly environmentally friendly and inexpensive cooling medium.

In an especially advantageous manner, the cooling or filling device according to the invention or the process according to the invention can be employed for the production of pharmaceutical metered dose aerosols. It has to be possible to administer the active ingredients via the inhalation route and to formulate them in conjunction with a propellant. Examples of preferred active ingredients include beclometasone 17,21 dipropionate, cromoglycinic acid, disodium salt, dexamethasone-21-isonicotinate, fenoterol-HBr, flunisolide ½H₂O, ipratropium bromide, orciprenaline sulfate, oxitropium bromide, reproterol-HCl, salbutamol, salbutamol sulfate and/or combinations of these.

The following are among the preferred products: Atrovent® metered dose aerosol, Berodual® metered dose aerosol, Combivent® metered dose aerosol, Ditec® metered dose aerosol, Tersigan® metered dose aerosol, Ventilat® metered dose aerosol, Auxiloson® metered dose aerosol, Berotec® metered dose aerosol, Inhacort® metered dose aerosol, Alupent® metered dose aerosol.

In this context, the products cited contain the following active ingredients:

Atrovent®: ipatropium bromide

Berodual®: ipatropium bromide in combination with fenoterol-HBr

Combivent®: salbutamol or salbutamol sulfate, each in combination with ipatropium bromide

Ditec®: fenoterol-HBr in combination with cromoglycinic acid, disodium salt

Tersigan®: oxitropium bromide

Ventilat®: oxitropium bromide

Auxiloson®: dexamethasone-21-isonicotinate

Berotec®: fenoterol-HBr

Inhacort®: flunisolide ½H₂O

Alupen®: orciprenaline sulfate

Examples of suitable propellant gases for pharmaceutical products are fluorochlorinated hydrocarbons and fluorinated hydrocarbons such as, for instance, TG 134a, TG 227, TG 11, TG 12, TG 114, 1,1,2,2-tetrafluoro-1,2-dichloroethane, dichlorodifluoromethane, trichlorofluoromethane, alkanes such as butane, propane and/or combinations of the propellant gases cited.

Examples of inert ingredients are pharmaceutically acceptable inert ingredients known from the state of the art. These include surfactants such as C₅₋₂₀ fatty alcohols, C₅₋₂₀ fatty acids, C₅₋₂₀ fatty acid esters, lecithin, glycerides, propylene glycol esters, polyoxyethylenes, polysorbates, sorbitane esters and/or carbohydrates. Preference is given to C₅₋₂₀ fatty acids, propylene glycol diesters and/or triglycerides and/or sorbitanes of C₅₋₂₀ fatty acids, whereby oleic acid and sorbitane mono-, di- or trioleates are especially preferred. As an alternative, toxicologically or pharmaceutically safe polymers and block polymers can be employed as suspension-stabilizing agents. The surface-active agents are either non-fluorinated or else partially or completely fluorinated, whereby the term fluorinated refers to the fact that hydrogen radicals bonded to carbon are substituted by fluorine radicals.

Other inert ingredients include co-solvents such as pharmacologically compatible alcohols such as ethanol, ester or water or else mixtures thereof. Ethanol is the preferred co-solvent.

Additional inert ingredients encompass acids and/or their salts. Especially well-suited are hydrochloric acid, sulfuric acid, nitric acid, phosphoric acid, ascorbic acid, citric acid and their salts.

Examples of preservatives that can be used are benzalconium chloride or ethylene diamine tetraacetate.

Examples of formulations will be presented below.

### EXAMPLE

ipatropium bromide, dichlorodifluoromethane, trichlorofluoromethane, 1,1,2,2-tetrafluoro-1,2-dichloroethane, soy lecithin.

### EXAMPLE 2

ipatropium bromide, fenoterol-HBr, dichlorodifluoromethane trichlorofluoromethane, 1,1,2,2-tetrafluoro-1,2-dichloroethane, sorbitane trioleate.

### EXAMPLE 3

fenoterol-HBr, cromoglycinic acid, disodium salt (DNCG), dichlorodifluoromethane, trichlorofluoromethane, 1,1,2,2-tetrafluoro-1,2-dichloroethane, sorbitane trioleate.

### EXAMPLE 4

oxitropium bromide, trichlorofluoromethane, dichlorodifluoromethane, 1,1,2,2-tetrafluoro-1,2-dichloroethane, soy lecithin.

### EXAMPLE 5

dexamethasone-21-isonicotinate, dichlorodifluoromethane, 1,1,2,2-tetrafluoro-1,2-dichloroethane, trichlorofluoromethane, sorbitane trioleate.

### EXAMPLE 6

fenoterol-HBr, tetrafluoroethane (TG 134a), citric acid, ethanol, water.

### EXAMPLE 7

flunisolide ½H₂O, dichlorodifluoromethane, trichlorofluoromethane, 1,1,2,2-tetrafluoro-1,2-dichloroethane, sorbitane trioleate.

### EXAMPLE 8

orciprenaline sulfate, dichlorodifluoromethane, trichlorofluoromethane, 1,1,2,2-tetrafluoro-1,2-dichloroethane, soy lecithin.

### EXAMPLE 9

reproterol-HCl, saccharin sodium, sorbitane trioleate, Dentomint PH 799959 (flavoring agent), trichlorofluoromethane, dichlorodifluoromethane, 1,1,2,2-tetrafluoro-1,2-dichloroethane.

### EXAMPLE 10

beclometasone dipropionate, trichlorofluoromethane, dichlorodifluoromethane, oleic acid.

### EXAMPLE 11

cromoglycinic acid, disodium salt, cryofluorane, dichlorodifluoromethane, trichlorofluoromethane, sorbitane trioleate.

### EXAMPLE 12

salbutamol sulfate, norflurane.

### EXAMPLE 13

cromoglycinic acid, disodium salt, reproterol-HCl, Tg 227, macrogole-25-glycerol trioleate, ethanol, saccharin-sodium, Dentomint PH 799959 (flavoring agent).

An embodiment of the invention will be explained in greater detail below with reference to the drawing.

The only drawing (FIGURE) schematically shows the set-up of the filling device according to the invention.

### The device 1 serves especially to fill aerosol formulations which are solutions or, in particular, suspensions consisting of an active ingredient to be atomized, for instance, a drug, and a readily volatile propellant such as fluorochlorinated hydrocarbons, fluorinated hydrocarbons, propane, butane, pentane, dimethyl ether, CO₂ or nitrogen, Frigen or a mixture of these. TG 227 and TG 134a are preferred as fluorinated hydrocarbons. After such aerosol formulations have been produced and prior to being filled into small canisters, they are stored in pressurized storage tanks in which, owing to the high vapor pressure of the propellant gas, a gradual pressure build-up to more than 5 bar can occur. In order to fill the product into aerosol canisters such as, for example, spray cans, inhalers and the like, the pressure is reduced to ambient pressure. For purposes of preventing a partial or complete evaporation of the propellant gas during the pressure-free filling procedure, the aerosol formulation is brought to a low temperature at which the gas pressure of the propellant gas is correspondingly less.

In the case of device 1, the product to be filled flows from the pressurized storage tank (not shown here) via a feed line 2 and via a cooling device 3 into a buffer tank 4. The buffer tank 4 is in flow connection with a metering means 6 via a product outflow line 5 that is connected to an outlet opening 7 of the buffer tank. The metering means 6 comprises a metering valve 9 by means of which the cooled product can be filled by familiar methods in metered doses so as to meet the requirements at hand. The feed line 2, the cooling device 3, the buffer tank 4 as well as the product outflow line 5 are provided with an insulating jacket 8, at least for the most part.

The cooling device 3 is delimited by a cylindrical inner wall 11 and by a likewise cylindrical outer wall 12 that is at a radial distance from the inner wall 11. The cooling device 3 is divided by a separating wall 10 into two annular areas 13, 14 which—from a geodetic perspective—are connected to each other in an upper section 15. The separating wall 10 is made of a material having good heat conductivity while the inner wall 11 and the outer wall 12 are insulated by the insulating jacket 8.

The evaporator area 14 located radially on the outside serves to evaporate a liquid coolant. For this purpose, the evaporator area 14 is in flow connection via a coolant feed line 16 to a storage tank (not shown here) for a liquid coolant 18, for instance, a tank for liquefied nitrogen. Housed in the heat exchanger area 13 located radially on the inside, which serves to hold a gaseous coolant, there is a cooling coil 19 that is in flow connection with the feed line 2. This cooling coil 19 is made of a highly conductive material and it exchanges heat with a gaseous coolant that flows through the heat exchanger area 13 when the device 1 is employed as designed. In this process, the gaseous coolant is generated in the evaporator area 14 by the evaporation of the liquid coolant 18, it then flows via the section 15 into the heat exchanger area 13 and exits it via a gas line 21.

The buffer tank 4, which is equipped with a motor-driven agitator 23 so as to produce the most homogenous suspension possible, is likewise in thermal contact with the coolant, ands so is the product line 5. In order to establish the thermal contact of the buffer tank 4, on the one hand, mid-sections 24 of its side walls are adjacent to the section 15 through which the gaseous coolant flows, whereby there is no thermal insulation on the side walls of the buffer tank 4 in this area and, on the other hand, the lower section of the buffer tank 4 has a double wall 25 whose delimiting walls enclose a cavity that is in flow connection with the gas line 21.

For purposes of the thermal contacting of the product outflow line 5, the latter has a double jacket 26 that encircles an annular gap. In the area of the outlet opening 7 of the buffer tank 4, the annular gap of the double jacket 26 opens into the cavity of the double wall 25. At the end opposite the outlet opening 7 as seen in the direction of flow, the annular gap of the double jacket 26 is connected to a gas outflow line 27.

The coolant feed line 16 is fitted with an adjustable valve 31 that is situated outside of the insulating jacket 8. Like the metering valve 9, the valve 31 can also be regulated by an electronic control unit 34 so as to regulate the inflows and outflows through the coolant feed line 16, through the gas outflow line 27 as well as through the product outflow line 5. By the same token, the inflow of product can be regulated in a manner not shown here.

When the device 1 is in operation, the product flows via the feed line 2 into the cooling coil 19 that serves as a pre-cooler, where it enters into thermal contact with the gaseous coolant present in the heat exchanger area 13. Through the regulation of the inflow of liquid coolant at the valve 31, the temperature of the gaseous coolant in the heat exchanger area 13 and thus the cooling capacity of the heat exchanger can be selected at will over a considerable temperature range. The valve 31 could be integrated into a control loop and, as a function of, for instance, the temperature or another physical or chemical parameter—which is detected by a measuring sensor 37 installed in the buffer tank 4—it can then be regulated by the electronic control unit 34.

After having passed through the cooling coil 19, the product flows through the feed line 35 to the buffer tank 4, a process during which the pressure of the product is reduced to ambient pressure by a reducing valve 36 integrated into the feed line 35. Consequently, the product is virtually pressure-free as it reaches the buffer tank 4.

Thanks to the continued thermal contact with the gaseous coolant, the product is prevented from heating up in the buffer tank 4. This thermal contact is achieved, on the one hand, by means of the mid-section 24 of the side wall of the buffer tank which, without an insulating intermediate layer, is directly adjacent to the section 15 filled with cold, gaseous coolant. On the other hand, the thermal contact is achieved via the double wall 25, and the gaseous coolant supplied by the gas line 21 flows through said cavity.

The product—which is homogenized in the buffer tank 4 in terms of its physical and chemical properties by means of the action of the agitator 23—flows via the product outflow line 5 to the metering means 6 where it is then filled into aerosol canisters such as inhalers. Here, the product continues to be cooled by the coolant flowing out of the cavity of the double wall 25 into the annular gap of the double jacket 26 of the product outflow line 5. The coolant subsequently flows out via the gas outflow line 27 and can then be recycled or further used.

After a filling batch, the device 1 can be heated up again to ambient temperature quickly and simply in that warm gaseous coolant, for instance, nitrogen, flows through the coolant paths 16, 14, 15, 13, 25, 26, 27.

The device 1 according to the invention allows the use of inexpensive and environmentally safe coolants, such as liquefied nitrogen, without creating the risk that the product might partially or completely freeze during the cooling procedure. The use of coolants having very low boiling temperatures such as helium or nitrogen also makes it possible to achieve product temperatures that cannot be reached using fluorochlorinated hydrocarbons as the cold medium. The controlled supply of the gaseous coolant also means that the cooling capacity of the cooling device 3 can be selected virtually at will, as a result of which the temperature of the substance can be kept at a prescribed value or along a prescribed temperature course with a high degree of precision.

Production Example for Pharmaceutical Formulations Berodual® Metered Dose Aerosol

1) Making the Concentrate (General Remarks)

The components of the formulation of the pharmaceutical preparation are mixed, if applicable, with partial amounts of the propellant under agitation and subsequently homogenized, if applicable. Subsequently, part of the propellant is added and once again briefly homogenized, if applicable.

2) Making the Product (General Remarks)

In the amounts stipulated in the production instructions, the concentrate from 1) is placed into the pressure vessel together with the propellant gas mixture to be used. The product is homogenized with the built-in agitator and subsequently filled batchwise under pressure and under cooling into the appertaining tank.

3) Filling the Product

Immediately after the appertaining tank has been filled, the product is filled in the desired target quantity into a clean and dry aerosol canister at a temperature of −45° C. [−49° F.] (ranging from −40° C. to −55° C. [−40° F. to −58° F. ]), after which the canister is sealed.

List of Reference Numerals

1 device

2 feed line

3 cooling device

4 buffer tank

4 product outflow line

6 metering means

7 outlet opening

8 thermal insulation

9 metering valve

10 separating wall

11 inner wall

12 outer wall

13 heat exchanger area

14 evaporator area

15 section

16 coolant feed line

17 -

18 liquid coolant

19 cooling coil

20 -

21 gas line

22 -

23 agitator

24 mid-section

25 double wall (of the buffer tank)

26 double wall (of the product outflow line)

27 gas outflow line

28 -

29 -

30 -

31 valve

32 -

33 -

34 electronic control unit

35 feed line

36 reducing valve

37 measuring sensor

38 inhaler

1. A device for the cryogenic cooling of aerosol batches liquefied in propellant gases, having an evaporator (14) for a liquid coolant (18), a heat exchanger (13) that is in flow connection with the evaporator (14) for purposes of establishing thermal contact between the evaporated coolant and the aerosol product batch, as well as a control unit (34) to regulate the cooling capacity of the heat exchanger.

2. The cooling device according to claim 1, characterized in that the control unit (34) has means (31) that serve to regulate the inflow of the liquid coolant to the evaporator.

3. The cooling device according to claim 1 or 2, characterized by an electronic control unit (34) which, as a function of a prescribed target value for the temperature or of a specified target temperature course, actuates the regulating means (31) that serves to regulate the inflow of liquid coolant.

4. A filling device for aerosol product batches having a feed line (16) for withdrawing an aerosol formulation from a pressure tank as well as a product outflow line (5) for feeding the aerosol product batch to a metering means (6), and having a cooling device (3) located upstream from the metering means (6), according to one of the preceding claims.

5. The filling device according to claim 4, characterized in that the feed line (2) is in flow connection with a buffer tank (4) that is preferably equipped with an agitator (23).

6. The filling device according to claim 5, characterized in that, for purposes of cooling the substance held in the buffer tank (4), the latter is provided, at least partially, with a double wall (25) and in that a coolant can flow through the cavity formed between the walls of this double wall (25).

7. The filling device according to one of claims 4 to 6, characterized in that the cooling device (3) comprises a pre-cooler (19) located upstream from the buffer tank (4).

8. The filling device according to claim 7, characterized in that the feed line (2) and/or the product outflow line (5) are associated with a unit (34) that serves to reduce the pressure to ambient pressure and that is located downstream from the pre-cooler (19).

9. A process to fill aerosol product batches in which an aerosol product batch is cooled in a cooling device (3) through thermal contact with a coolant, after which it is conveyed in the cold state to a metering means (6) used for filling the product into aerosol canisters (38), characterized in that
a liquefied gas is used as the coolant that is evaporated prior to thermal contact with the aerosol product batch.

10. The process according to claim 9, characterized in that the temperature of the evaporated liquefied gas is regulated by controlling the pressure and/or by supplying liquefied gas.

11. The process according to claim 9 or 10, characterized in that nitrogen is employed as the coolant.

12. Use of the device according to one of claims 1 through 8 of the process according to one of claims 9 to 11 in order to produce metered dose aerosols containing a propellant gas selected from the group consisting of TG 134a, TG 227, TG 11, TG 12, TG 114, 1,1,2,2-tetrafluoro-1,2-dichloroethane, dichlorodifluoromethane, trichlorofluoromethane, butane and/or propane and active ingredients selected from the group consisting of beclometasone 17,21 dipropionate, cromoglycinic acid, disodium salt, dexamethasone-21-isonicotinate, fenoterol-HBr, flunisolide ½H₂O, ipratropium bromide, orciprenaline sulfate, oxitropium bromide, reproterol-HCl, salbutamol, salbutamol sulfate and/or combinations of these.

13. The use according to claim 12 for the production of Atrovent® metered dose aerosol, Berodual® metered dose aerosol, Combivent® metered dose aerosol, Ditec® metered dose aerosol, Tersigan® metered dose aerosol, Ventilat® metered dose aerosol, Auxiloson® metered dose aerosol, Berotec® metered dose aerosol, Inhacort® metered dose aerosol or Alupent® metered dose aerosol.
